(19) United States
(12) Patent Application Publication
(10) Pub. No.: US 2017/0270368 A1
(43) Pub. Date: Sep. 21, 2017

(54) METHOD FOR DETECTING A SOILING OF AN OPTICAL COMPONENT OF A DRIVING ENVIRONMENT SENSOR USED TO CAPTURE A FIELD SURROUNDING A VEHICLE; METHOD FOR AUTOMATICALLY TRAINING A CLASSIFIER; AND A DETECTION SYSTEM

(71) Applicant: Robert Bosch GmbH, Stuttgart (DE)

(72) Inventors: Christian Gosch, Sunnyvale, CA (US); Stephan Lenor, Stuttgart (DE); Ulrich Stopper, Gerlingen (DE)

(21) Appl. No.: 15/449,407

(22) Filed: Mar. 3, 2017

(30) Foreign Application Priority Data
Mar. 15, 2016 (DE) 102016204206.8

(51) Int. Cl. G06K 9/00; H04N 7/18; G06K 9/66; G06K 9/62; G06K 9/46

(52) U.S. Cl. CPC G06K 9/00791; G06K 9/6267; G06K 9/6201; G06K 9/4642; G06K 9/4661; G06K 9/66; H04N 7/183

(57) ABSTRACT

A method for detecting a soiling of an optical component of a driving environment sensor for capturing a field surrounding a vehicle. An image signal, which represents at least one image region of at least one image captured by the driving environment sensor, is input here. The image signal is subsequently processed using at least one automatically trained classifier to detect the soiling in the image region.

### RELATED APPLICATION INFORMATION

The present application claims priority to and the benefit of German patent application No. 10 2016 204 206.8, which was filed in Germany on Mar. 15, 2016, the disclosure of which is incorporated herein by reference.

### FIELD OF THE INVENTION

The present invention relates to a device or to a method according to the species defined in the independent claims. The present invention is also directed to a computer program.

### BACKGROUND INFORMATION

An image captured by a vehicle's camera system can be adversely affected by the soiling of a camera lens, for example. A model-based method can be used, for example, to improve such an image.

### SUMMARY OF THE INVENTION

Against this background, the approach presented here introduces a method for detecting a soiling of an optical component of a driving environment sensor used for capturing a field surrounding a vehicle; a method for automatically training a classifier; in addition, a device that uses this method; a detection system, as well as, finally, a corresponding computer program in accordance with the main claims. Advantageous embodiments of the device indicated in the main descriptions herein and improvements thereto are rendered possible by the measures delineated in the further descriptions herein.

A method is presented for detecting a soiling of an optical component of a driving environment sensor used for capturing a field surrounding a vehicle; the method including the following steps:

inputting an image signal, that represents at least one region of at least one image captured by the driving environment sensor; and

processing the image signal using at least one automatically trained classifier to detect the soiling in the image region.

Soiling may generally be understood to be covering the optical component or, thus, adversely affecting an optical path of the driving environment sensor that includes the optical component. The covering may be caused by dirt or water, for example. An optical component may be understood to be a lens, a wafer or a mirror, for example. In particular, the driving environment sensor may be an optical sensor. A vehicle may be understood to be a motor vehicle, such as an automobile or truck. An image region may be understood to be a subregion of the image. A classifier may be understood to be an algorithm for automatically performing a classification process. The classifier may be trained by machine learning, for instance, by monitored learning outside of the vehicle or by online training during an operation of the classifier, to be able to distinguish at least between two categories that may represent different soiling levels of the optical component, for example.

The approach described here is based on the realization that, by implementing a classification, an automatically trained classifier is able to detect soiling and similar phenomena in an optical path of a video camera.

A video system in a vehicle may include a driving environment sensor, for example, in the form of a camera, that is installed on the outside of a vehicle and thus may be directly exposed to environmental influences. In particular, a camera lens may become soiled over time, for example, by dirt whirled up from the road surface, by insects, mud, raindrops, icing, condensation or dust from the ambient air. Soiling may also adversely affect the functioning of video systems installed in the passenger compartment that may be adapted, for example, for capturing images though another element, such as a windshield. Also conceivable is a soiling in the form of a camera image being permanently covered due to damage to an optical path.

Using the approach presented here, a camera image or even sequences thereof may be classified by an automatically trained classifier in a way that not only allows soiling to be recognized, but, moreover, localized in the camera image accurately, rapidly, and with relatively little computational outlay.

In accordance with one specific embodiment, a signal may be input in the inputting step as an image signal that represents at least one further region of the image. In the processing step, the image signal may be processed to detect the soiling in the image region and, additionally or alternatively, to detect the further image region. The further image region may be a subregion of the image located outside of the image region, for example. For example, the image region and the further image region may be mutually adjacently disposed and essentially have the same size or shape. Depending on the specific embodiment, the image may be subdivided into two image regions or also into a plurality of image regions. This specific embodiment makes it possible to efficiently analyze the image signal.

In another specific embodiment, a signal may be input in the inputting step as the image signal that, as the further image region, represents an image region which spatially deviates from the image region. It is thereby possible to localize the soiling in the image.

It is advantageous when a signal is input in the inputting step as the image signal that, as the further image region, represents an image region which deviates from the image region in terms of a capture instant. The image region and the further image region may be thereby mutually compared in a comparison step, using the image signal, in order to ascertain any deviation between the features of the image region and features of the further image region. Accordingly, in the step of processing the image signal, the image signal may be detected as a function of the feature deviation. The features may be specific pixel regions of the image region or of the further image region. The deviation in features may represent the soiling, for example. This specific embodiment makes possible a pixel-precise localization of the soiling in the image.

Moreover, the method may include a step of forming a grid from the image region and the further image region using the image signal. In the processing step, the image signal may be processed to detect the soiling within the grid. The grid may, in particular, be a regular grid of a plurality of rectangles or squares as image regions. This specific embodiment, as well, may enhance the efficiency attained in localizing the soiling.

Another specific embodiment provides that the image signal be processable in the processing step in order to detect the soiling using at least one illumination classifier to distinguish among various illumination situations representing an illumination of the surrounding field. Analogously to the classifier, an illumination classifier may be understood to be an algorithm that has been adapted by machine learning. An illumination situation may be understood to be a situation characterized by specific image parameters, such as brightness or contrast values, for instance. The illumination classifier may be adapted to distinguish between day and night, for example. This specific embodiment makes it possible to detect the soiling as a function of the illumination of the surrounding field.

In addition, the method may include a step of automatically training a classifier in accordance with a specific embodiment in the following. In the processing step, the image signal may be processed in order to detect the soiling by allocating the image region to the first or second soiling category. The automatic training step may be performed inside of the vehicle, in particular during an operation thereof. This allows a rapid and accurate detection of the soiling.

The approach described here also provides a method for automatically training a classifier for use in a method in accordance with one of the preceding specific embodiments; the method including the following steps:

reading in training data, that at least represent image data captured by the driving environment sensor, possibly also additionally sensor data captured by at least one further sensor of the vehicle; and

training the classifier using the training data in order to distinguish between at least a first and a second soiling category; the first and the second soiling category representing different soiling levels and/or different soiling types and/or different soiling effects.

The image data may be an image or an image sequence, for example, it being possible for the image or the image sequence to have been captured in a soiled state of the optical component. Image regions may be identified here that have such a soiling. The further sensor maybe an acceleration sensor or steering angle sensor of the vehicle, for example. Accordingly, the sensor data may be acceleration values or steering angle values of the vehicle. The method may either be implemented outside of the vehicle or inside of the vehicle as a step of a method in accordance with one of the preceding specific embodiments.

In any case, the training data, also referred to as a training data record, contain image data since the later classification is also mainly based on image data. In addition to the image data, data from other sensors may possibly be used.

These methods may be implemented, for example, in software or hardware or in a software and hardware hybrid, in a control unit, for example.

The approach presented here also provides a device that is adapted for performing, controlling or realizing the steps of a variant of a method presented here in corresponding devices. This design variant of the present invention in the form of a device also makes it possible for the object of the present invention to be achieved rapidly and efficiently.

To this end, the device may feature at least one processing unit for processing signals or data, at least one memory unit for storing signals or data, at least one interface to a sensor or an actuator for inputting sensor signals from the sensor or for outputting data signals or control signals to the actuator and/or at least one communication interface for reading in or reading out data that are embedded in a communication protocol. The processing unit may be a signal processor, a microcontroller or the like, for example, it being possible for the memory unit to be a flash memory, an EPROM or a magnetic memory unit. The communication interface may be adapted for reading in or reading out data wirelessly and/or by wire; a communication interface, capable of reading in or outputting data by wire, then reading in these data, for example, electrically or optically from a corresponding data transmission line or outputting them into a corresponding data transmission line.

A device may be understood here to be an electrical device that processes sensor signals and outputs control and/or data signals as a function thereof. The device may have an interface implemented in hardware and/or software. When implemented in hardware, the interfaces maybe the part of what are commonly known as system ASICs, for example, that includes a wide variety of device functions. However, the interfaces may also be separate, integrated circuits or be at least partially composed of discrete components. When implemented in software, the interfaces may be software modules that are present on a microcontroller, for example, in addition to other software modules.

In one advantageous embodiment, the device controls a driver assistance system of the vehicle. To this end, the device may access sensor signals, such as surrounding-field signals, acceleration signals or steering-angle sensor signals. The control takes place via actuators, such as steering or brake actuators or a motor controller of the vehicle.

In addition, the approach described here provides a detection system having the following features:

a driving environment sensor for generating an image signal; and

a device in accordance with a preceding specific embodiment.

Also advantageous is a computer program product or computer program having program code, which may be stored on a machine-readable carrier or storage medium, such as a semiconductor memory, a hard-disk memory or an optical memory, and is used to carry out, implement and/or control the steps of the method in accordance with one of the aforedescribed specific embodiments, particularly when the program product or program is executed on a computer or a device.

Exemplary embodiments of the present invention are illustrated in the drawing and explained in greater detail in the following description.

In the following description of advantageous exemplary embodiments of the present invention, the same or similar reference numerals are used for the elements that are shown in the various figures and whose function is similar, there being no need to repeat the description of these elements.

### BRIEF DESCRIPTION OF THE DRAWINGS

FIG. 1 schematically shows a vehicle having a detection system in accordance with an exemplary embodiment.

FIG. 2 schematically shows images for a device to analyze in accordance with an exemplary embodiment.

FIG. 3 schematically shows images from FIG. 2.

FIG. 4 schematically shows an image for a device to analyze in accordance with an exemplary embodiment.

FIG. 5 schematically shows a device in accordance with an exemplary embodiment.

FIG. 6 is a flow chart of a method in accordance with an exemplary embodiment.

FIG. 7 is a flow chart of a method in accordance with an exemplary embodiment.

FIG. 8 is a flow chart of a method in accordance with an exemplary embodiment.

FIG. 9 is a flow chart of a method in accordance with an exemplary embodiment.

### DETAILED DESCRIPTION

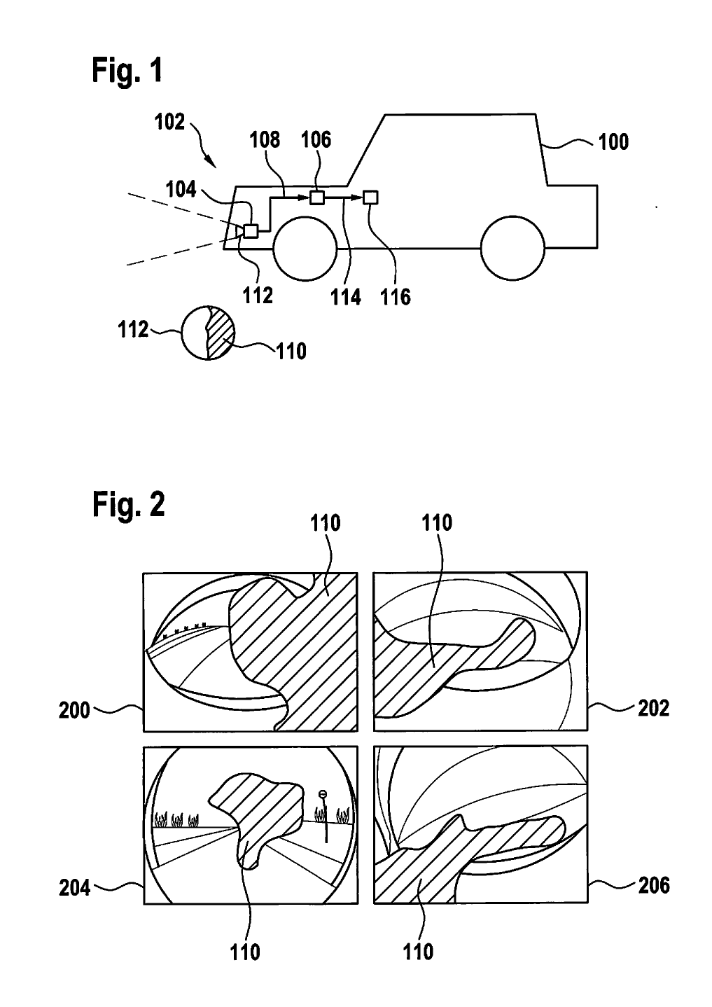

FIG. 1 schematically shows a vehicle 100 having a detection system 102 in accordance with an exemplary embodiment. Detection system 102 includes a driving environment sensor 104, in this case a camera, as well as a device 106 connected thereto. Driving environment sensor 104 is adapted for capturing a field surrounding vehicle 100 and for transmitting an image signal 108 representing the surrounding field to device 106. Here, image signal 108 represents at least a subregion of a surrounding field image captured by driving environment sensor 104. Device 106 is adapted for detecting a soiling 110 of an optical component 112 of driving environment sensor 104 using image signal 108 and at least one automatically trained classifier. Device 106 uses the classifier in order to analyze the subregion represented by image signal 108 in terms of soiling 110. To facilitate understanding, optical component 112, here, exemplarily, a lens, is shown in an enlarged view adjacent to vehicle 100, soiling 110 being identified by a hatched surface.

In accordance with an exemplary embodiment, device 106 is adapted for generating a detection signal 114 in response to a detection of soiling 110 and for outputting the same to an interface to a control unit 116 of vehicle 100. Control unit 116 may be adapted for controlling vehicle 100 using detection signal 114.

FIG. 2 shows a schematic representation of images 200, 202, 204, 206 for a device 106 to analyze in accordance with an exemplary embodiment, for instance a device as previously described with reference to FIG. 1. The four images may be contained in the image signal, for example. Shown are soiled regions on different lenses of the driving environment sensor, in this case of a four-camera system, that is able to capture the field surrounding the vehicle in four different directions—to the front, to the rear, to the left, and to the right. The regions of soiling 110 are each shown in hatched shading.

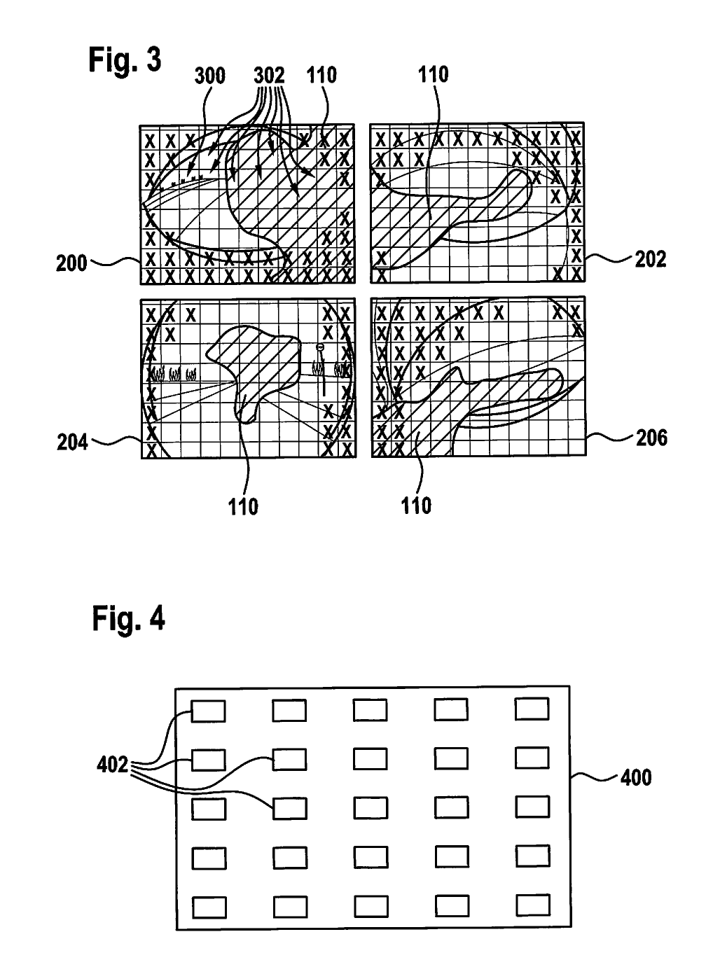

FIG. 3 schematically shows images 200, 202, 204, 206 from FIG. 2. In contrast to FIG. 2, the four images in accordance with FIG. 3 are each subdivided into an image region 300 and into a plurality of further image regions 302. In accordance with this exemplary embodiment, image regions 300, 302 are square and are disposed mutually adjacently in a regular grid. Image regions, which are permanently covered by in-vehicle components and are, therefore, not included in the analysis, are each marked by a cross. The device is adapted here to process the image signal representing images 200, 202, 204, 206 in a way that allows soiling 110 to be detected in at least one of image regions 300, 302.

For example, a value 0 in an image region corresponds to a recognized clear view, and a value unequal to 0 to a recognized soiling.

FIG. 4 schematically shows an image 400 for a device to analyze in accordance with an exemplary embodiment. Image 400 shows soiling 110. Also discernible are probability values 402 in blocks for the device to analyze using a blurriness category of blindness causes. Probability values 402 may each be assigned to an image region of image 400.

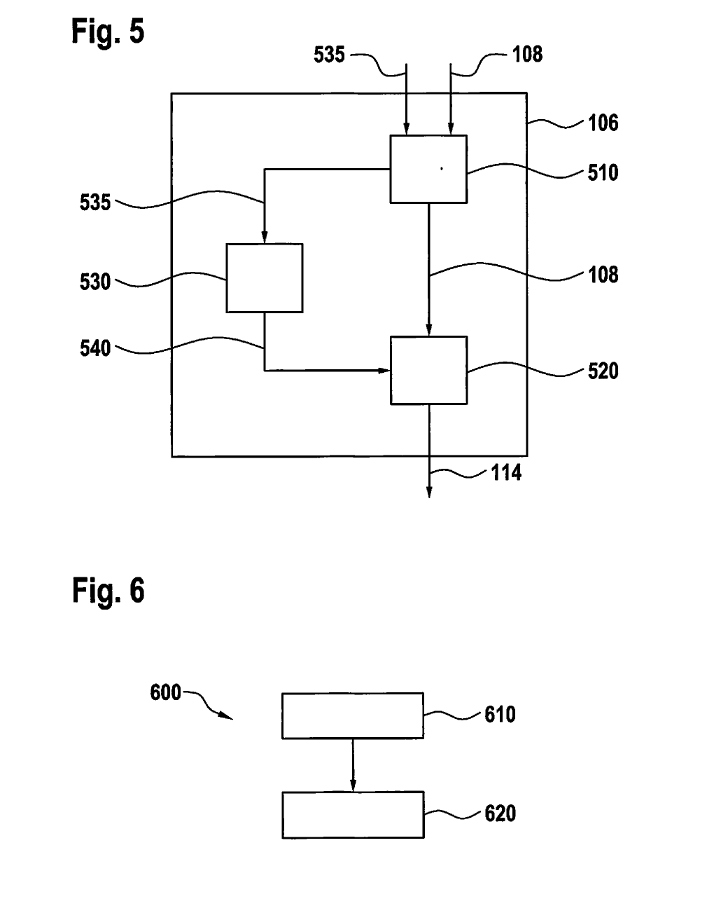

FIG. 5 schematically shows a device 106 in accordance with an exemplary embodiment. For example, device 106 may be a device as previously described with reference to FIGS. 1 through 4.

Device 106 includes an input unit 510 that is adapted for inputting image signal 108 via an interface to the driving environment sensor and for transmitting it to a processing unit 520. Image signal 108 represents one or a plurality of regions of an image captured by driving environment sensor, such as image regions, as previously described with reference to FIG. 2 through 4. Processing unit 520 is adapted for processing image signal 108 using the automatically trained classifier and for thereby detecting the soiling of the optical component of the driving environment sensor in at least one of the image regions.

As already described with reference to FIG. 3, processing unit 520 may arrange the image regions here in a grid mutually spatially separately. For example, the soiling is detected in that the classifier assigns the image regions to different soiling categories which each represent a soiling level.

One exemplary embodiment also provides that processing unit 520 process image signal 108 by using an optional illumination classifier that is adapted for distinguishing among different illumination situations. It is thus possible, for example, for the illumination classifier to detect the soiling as a function of a brightness when the driving environment sensor captures the surrounding field.

One optional exemplary embodiment provides that processing unit 520 be adapted to be responsive to the detection by outputting detection signal 114 to the interface of the vehicle's control unit.

Another exemplary embodiment provides that device 106 include a learning unit 530 that is adapted for reading in training data 535 via input unit 108 that include image data supplied by the driving environment sensor depending on the exemplary embodiment or sensor data supplied by at least one further sensor of the vehicle, and for adapting the classifier using machine learning on the basis of training data 535, thereby enabling the classifier to distinguish between at least two different soiling categories that represent a soiling level, a soiling type, or a soiling effect, for instance. Learning unit 530 automatically trains the classifier continuously, for example. Learning unit 530 is also adapted for transmitting classifier data 540 representing the classifier to processing unit 520; processing unit 520 using classifier data 540 to analyze image signal 108 with regard to soiling by utilizing the classifier.

FIG. 6 is a flowchart of a method 600 in accordance with an exemplary embodiment. Method 600 for detecting a soiling of an optical component of a driving environment sensor may be implemented or controlled, for example, in connection with a device described in the preceding with reference to FIG. 1 through 5. Method 600 includes a step 610 in which the image signal is input via the interface to the driving environment sensor. In a further step 620, the image signal is processed using the classifier in order to detect the soiling in the at least one image region represented by the image signal.

Steps 610, 620 may be executed continuously.

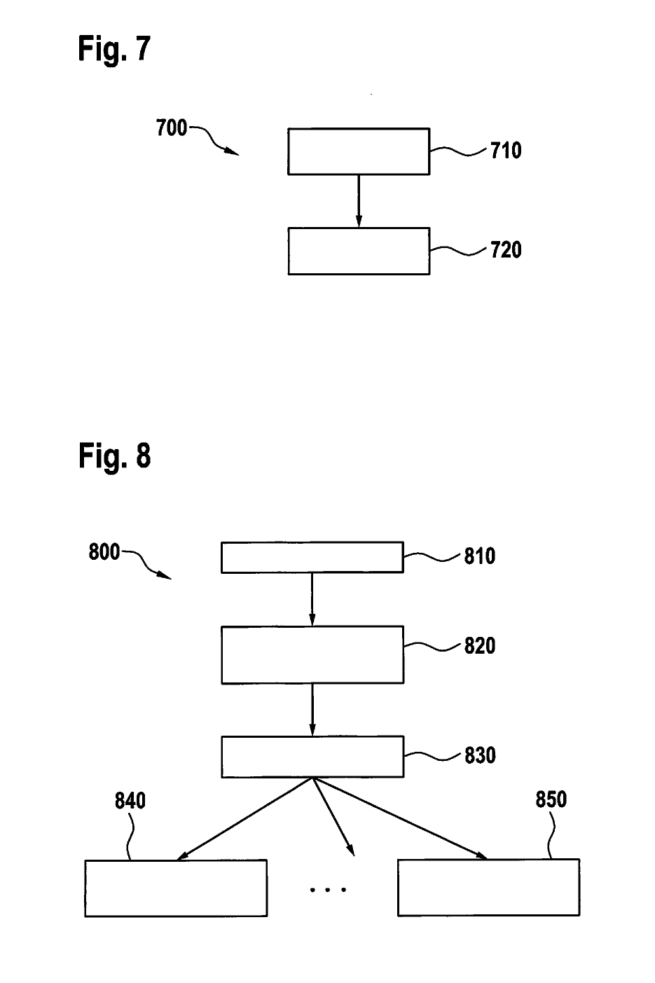

FIG. 7 is a flowchart of a method 700 in accordance with an exemplary embodiment. Method 700 for automatically training a classifier, for instance, a classifier as described in the preceding with reference to FIG. 1 through 6, includes a step 710 in which training data are read in that are based on image data of the driving environment sensor or sensor data of other sensors of the vehicle. For example, the training data may include markings for identifying soiled regions of the optical component in the image data. In another step 720, the classifier is trained using the training data. As a result of this training, the classifier is able to distinguish between at least two soiling categories, which, depending on the specific embodiment, represent different soiling levels, soiling types or soiling effects.

In particular, method 700 may be implemented outside of the vehicle. Methods 600, 700 may be implemented mutually independently.

FIG. 8 is a flow chart of a method 800 in accordance with an exemplary embodiment. Method 800 may be a part of a method described in the preceding with reference to FIG. 6. A general case of using method 800 to detect a soiling is shown. In a step 810, a video stream provided by the driving environment sensor is input here. In another step 820, the video stream is temporally and spatially partitioned. In the case of the spatial partitioning, an image stream represented by the video stream is subdivided into image regions, which, depending on the exemplary embodiment, are disjoint or not disjoint.

In another step 830, a spatial-temporal, localized classification is carried out using the image regions and the classifier. A function-specific blindness assessment is made in a step 840 as a function of a classification result. In a step 850, a corresponding soiling indication is output as a function of the classification result.

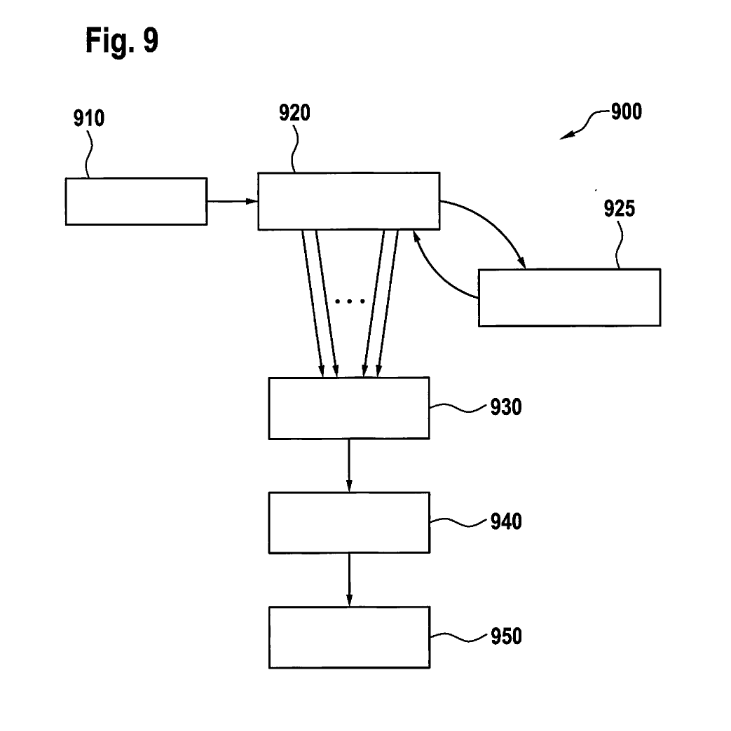

FIG. 9 shows a flow chart of a method 900 in accordance with an exemplary embodiment. Method 900 may be a part of a method described in the preceding with reference to FIG. 6. In a step 910, a video stream provided by the driving environment sensor is input here. Using the video stream, features are computed spatially-temporally in a step 920. In an optional step 925, indirect features may be computed from the direct features computed in step 920. In another step 930, a classification is carried out using the video stream and the classifier. An accumulation takes place in a step 940. Finally, in a step 950, a result regarding a soiling of the driving environment sensor's optical component is output as a function of the accumulation.

Various exemplary embodiments of the present invention are explained again in greater detail in the following.

A soiling of the lenses is to be detected and localized in a camera system installed on or in the vehicle. In camera-based driver assistance systems, information on a soiling state of the cameras, for example, is to be transmitted to other functions that are able to adapt the characteristics thereof thereto. Thus, for example, an automatic park function is able to decide whether the image data available thereto or data derived from the images were captured using sufficiently clean lenses. From this, such a function is able to infer, for example, that they are available only partially or not at all.

The approach presented here combines a plurality of steps. Depending on the exemplary embodiment, they may be executed partly outside of, partly inside of a camera system installed in the vehicle.

To this end, a method learns how image sequences from soiled cameras typically appear and how image sequences from cameras that are not soiled appear. An algorithm, also referred to as a classifier, implemented in the vehicle uses this information to classify new image sequences during operation as soiled or not soiled.

No fixed, physically motivated model is assumed. Instead, from existing data, it is learned how to distinguish between a clean and a soiled viewing zone. It is thereby possible to perform the learning phase outside of the vehicle only once, for instance, off-line by monitored learning, or to adapt the classifier during operation, i.e., online. These two learning phases may also be mutually combined.

The classification may be very efficiently modeled and implemented, making it suited for use in embedded vehicle systems. In contrast, in the case of off-line training, the degree of complexity for execution time and memory is not important here.

Instead, the image data may be considered in the entirety thereof or reduced beforehand to suitable properties in order to reduce the computational outlay for the classification, for example. Moreover, it is possible to not only use two categories, such as soiled and not soiled, for example, but also to make more exact distinctions in soiling categories, such as clear view, water, mud or ice or effect categories, such as clear view, blurred, fuzzy, to noisy. Moreover, the image may be spatially subdivided at the beginning into subregions that are processed mutually spatially separately. This makes it possible to localize the soiling.

Image data and other data from vehicle sensors, such as vehicle velocity and other state variables of the vehicle, are recorded, for example, and soiled regions in the recorded data are identified, also referred to as labeling. The thus identified training data are used for training a classifier to distinguish between soiled and unsoiled image regions. This step takes place off-line, i.e., outside of the vehicle and is only repeated, for example, when there are changes in the training data. This step is not executed during operation of a delivered product. However, it is also conceivable that the classifier is changed during operation of the system, thereby continuously adding to the system's learning. This is also referred to as online training.

The result of this learning step is used in the vehicle to classify image data recorded during operation. The image is thereby not necessarily subdivided into disjoint regions. The image regions are classified individually or in groups. This subdivision may be oriented to a regular grid, for example. The subdivision makes it possible to realize the localization of the soiling in the image.

In one exemplary embodiment, where the learning takes place during operation of the vehicle, the step of off-line training may be omitted. The classification is then learned in the vehicle.

Problems may arise, inter alia, due to different illumination conditions. These may be resolved in different ways, for example, by learning the illumination in the training step. Another option provides for training different classifiers for different illumination situations, in particular for day and night. To switch between various classifiers, for example, brightness values are used as input variables for the system. Brightness values may have been determined, for example, by cameras connected to the system. Alternatively, the brightness may also be directly included as a feature in the classification.

In accordance with another exemplary embodiment, features M1 are ascertained and stored for one image region at an instant t1. At an instant t2>t1, the image region is transformed in accordance with a vehicle movement; features M2 for the transformed region being computed once more. An occlusion leads to a significant change in the features and may thereby be recognized. New features, which are computed from features M1, M2, may also be learned as features for the classifier.

In accordance with an exemplary embodiment, the features

fₕ:R^{t}^{ᵢ}→R,i∈I, k=1, . . . N,

are computed for Tₖ input values at points I=N×N in image region Ω. Input values are thereby the image sequence, temporal and spatial information derived therefrom, as well as further information that the entire vehicle system makes available. In particular, information from the vicinity, that is not local, n:I→P(I) is also used; P(I) denoting the power set of I for calculating a subset of the features. At i∈I, this information that is not local is composed of the primary input values, as well as of fⁱ, j∈n(i)

If

$$T = \{ {t}_{i} ⋐ I \vert ( {t}_{i} ⋂ {t}_{j} = 0 , i \neq j ) ⋀ {⋃}_{i = 1}^{{N}_{T}} {t}_{i} = I \}$$

the subdivision of image points I in N_{T} image regions tᵢ (here: tiles) is the classification at each of image points I. yᵢ(f)=0 signifies a classification as clean and yᵢ(f)=I, a classification as covered. \tilde{y}:T→{0,..., k} assigns an assessment of coverage to a tile. This is computed as

$$\tilde{y} ( {t}_{j} ) = ⌊ \frac{{\sum }_{i ∈ {t}_{j}} {y}_{i} ( {f}^{i} )}{\vert {t}_{j} \vert} K ⌋$$

including a norm |tⱼ| above the tiles. For example, |tⱼ|=1 may be set. Depending on the system, it holds that K=3.

If an exemplary embodiment includes an “AND/OR” logic operation between a first feature and a second feature, then this is to be read as the exemplary embodiment in accordance with a specific embodiment having both the first feature, as well as the second feature and, in accordance with another specific embodiment, either only the first feature or only the second feature.

What is claimed is:

1. A method for detecting a soiling of an optical component of a driving environment sensor used to capture a field surrounding a vehicle, the method comprising:
inputting an image signal that represents at least one image region of at least one image captured by the driving environment sensor; and
processing the image signal using at least one automatically trained classifier to detect the soiling in the image region.

2. The method of claim 1, wherein, in the inputting, a signal is input as the image signal that represents at least one further image region of the image, and wherein the image signal is processed in the processing to detect the soiling in at least one of the image region and the further image region.

3. The method of claim 2, wherein, in the inputting, a signal is input as the image signal that, as the further image region, represents an image region that spatially deviates from the image region.

4. The method of claim 2, wherein, in the inputting, a signal is input as the image signal that, as the further image region, represents an image region that deviates from the image region in terms of a capture instant, further comprising:
comparing the image region and the further image region using the image signal, to ascertain any deviation between the features of the image region and features of the further image region;
wherein, in the processing, the image signal is detected as a function of the feature deviation.

5. The method of claim 2, further comprising:
forming a grid from the image region and the further image region using the image signal;
wherein, in the processing, the image signal is processed to detect the soiling within the grid.

6. The method of claim 1, wherein, in the processing, the image signal is processed to detect the soiling using at least one illumination classifier to distinguish among various illumination situations representing an illumination of the surrounding field.

7. A method for detecting a soiling of an optical component of a driving environment sensor used to capture a field surrounding a vehicle, the method comprising:
inputting an image signal that represents at least one image region of at least one image captured by the driving environment sensor;
processing the image signal using at least one automatically trained classifier to detect the soiling in the image region; and
automatically training a classifier, by performing the following:
reading in training data, which at least represent image data captured by the driving environment sensor; and
training the classifier using the training data to distinguish between at least a first soiling category and a second soiling category, wherein the first soiling category and the second soiling category represent at least one of different soiling levels, different soiling types, and different soiling effects;
wherein in the processing, the image signal is processed to detect the soiling by allocating the image region to the first soiling category or the second soiling category.

8. A method for automatically training a classifier, the method comprising:
reading in training data, which at least represent image data captured by the driving environment sensor; and
training the classifier using the training data to distinguish between at least a first soiling category and a second soiling category, wherein the first soiling category and the second soiling category represent at least one of different soiling levels, different soiling types, and different soiling effects.

9. The method of claim 8, wherein the training data, which represent sensor data captured by at least one further sensor of the vehicle, are also read-in in the inputting.

10. A device for detecting a soiling of an optical component of a driving environment sensor used to capture a field surrounding a vehicle, comprising:
an input arrangement to input an image signal that represents at least one image region of at least one image captured by the driving environment sensor; and
a processing arrangement to process the image signal using at least one automatically trained classifier to detect the soiling in the image region.

11. A detection system, comprising:
a driving environment sensor to generate an image signal; and
a device for detecting a soiling of an optical component of a driving environment sensor used to capture a field surrounding a vehicle, including:
an input arrangement to input an image signal that represents at least one image region of at least one image captured by the driving environment sensor; and
a processing arrangement to process the image signal using at least one automatically trained classifier to detect the soiling in the image region.

12. A computer readable medium having a computer program, which is executable by a processor, comprising:
a program code arrangement having program code for detecting a soiling of an optical component of a driving environment sensor used to capture a field surrounding a vehicle, by performing the following:
inputting an image signal that represents at least one image region of at least one image captured by the driving environment sensor; and
processing the image signal using at least one automatically trained classifier to detect the soiling in the image region.

13. A computer readable medium of claim 12, wherein, in the inputting, a signal is input as the image signal that represents at least one further image region of the image, and wherein the image signal is processed in the processing to detect the soiling in at least one of the image region and the further image region.
